(19) United States
(12) Patent Application Publication
(10) Pub. No.: US 2004/0015831 A1
(43) Pub. Date: Jan. 22, 2004

(54) Method and apparatus for building software packages

(76) Inventor: Allan J.C. Bowhill, Renton, WA (US)

Correspondence Address: PARK, VAUGHAN & FLEMING LLP, 508 SECOND STREET, SUITE 201, DAVIS, CA, 95616, US

(21) Appl. No.: 09/773,858

(22) Filed: Jan. 31, 2001

(51) Int. Cl. G06F 9/44; G06F 9/445

(52) U.S. Cl. 717/106; 717/174

(57) ABSTRACT

One embodiment of the present invention provides a system for building software packages. This system operates by receiving files from a remote repository as each port is being built. Next, the system creates a batch file for each software package to be built, wherein the batch file specifies instructions for creating an executable file for each software package. These batch files are assigned to a plurality of queues such that the workload is divided substantially equally across the queues. During processing of the batch files, each queue is served by a virtual server from a plurality of virtual servers, wherein the plurality of virtual servers resides within one computing device, and wherein each virtual server of the plurality of virtual servers can provide essentially all services of a complete computing device. Finally, the system stores the executable file for each software package in a directory structure, wherein a user can select a software package for use.

### BACKGROUND

1. Field of the Invention

The present invention relates to computer software packages. More specifically, the present invention relates to compiling and packaging third-party software programs from a public domain collection and making the software packages available to customers.

2. Related Art

Many computer users are beginning to use open-source software as an alternative to proprietary software that is distributed through conventional means.

The FreeBSD group maintains a collection of computer source code that has been contributed by many individuals and is know as the FreeBSD ports collection. Currently, there are approximately four thousand packages available, which include such software as operating systems, text editors, web browsers, e-mail programs, and other useful packages.

Typically, a user downloads the various source files, makes any desired modifications to the source code, and then compiles and links the source code into executable files, which are installed into a library on a computing device. Some vendors have created systems that download all of the ports and create executable files for all of the various packages, which will run on a specific type of computing device. Note that a port is computer source code that can be compiled for any of a number of different computing devices.

Programmers associated with the FreeBSD group have developed a number of open-source scripts that are used to build FreeBSD software packages in parallel, using multiple machines across a network. Using these scripts, the system creates daily builds of the entire FreeBSD ports collection and makes the resulting packages part of a “daily snapshot”, which includes the FreeBSD operating system, ports collection and all packages made from these ports.

Vendors desiring to make available a customized version of the FreeBSD ports can use the FreeBSD scripts to build the packages. However, these scripts have many drawbacks, including inadequate documentation to fully set up and maintain the system, awkward and possibly insecure uses of the network file system (NFS) and secure shell (SSH), and lack of a central management tool or console application to control and monitor the build process.

Moreover, the FreeBSD scripts rely on a single computing device to do job dispatching in order to assign a port build to a specific computing device. One or more additional computing devices actually build the ports. Furthermore, under the FreeBSD scripts, a single computing device cannot be used to perform the entire process of job dispatching and port building.

What is needed is a method and apparatus for building customized versions of ports collections, such as the FreeBSD ports collection, while eliminating the drawbacks listed above.

### SUMMARY

One embodiment of the present invention provides a system for building software packages. This system operates by receiving files from a remote repository as each port is being built. Next, the system creates a batch file for each software package to be built, wherein the batch file specifies instructions for creating an executable file for each software package. These batch files are assigned to a plurality of queues such that the workload is divided substantially equally across the queues. During processing of the batch files, each queue is served by a virtual server from a plurality of virtual servers, wherein the plurality of virtual servers resides within one computing device, and wherein each virtual server of the plurality of virtual servers can provide essentially all services of a complete computing device. Finally, the system stores the executable file for each software package in a directory structure, wherein a user can select a software package for use.

In one embodiment of the present invention, the system customizes the collection of source files. After customizing the collection of source files, the system copies the collection of source files to a local repository.

In one embodiment of the present invention, the system generates an index of software packages to be built. Additionally, the system includes packages within the index upon which the software package depends.

In one embodiment of the present invention, the system builds packages upon which the software package depends prior to building the software package.

In one embodiment of the present invention, the batch file is assigned to a queue in the plurality of queues such that each queue of the plurality of queues has a substantially equal workload.

In one embodiment of the present invention, the system associates the queue with a specific virtual server, wherein the specific virtual server receives batch files from the queue associated with the specific virtual server only.

In one embodiment of the present invention, the system checks the directory structure to determine if the software package has already been built prior to building the software package. If the software package has already been built, the system does not build the software package a second time.

In one embodiment of the present invention, the system additionally creates a new index of software packages in the directory structure for use by the user.

In one embodiment of the present invention, the plurality of virtual servers can reside on multiple computing devices.

### BRIEF DESCRIPTION OF THE FIGURES

FIG. 1 illustrates computing devices coupled together in accordance with an embodiment of the present invention.

FIG. 2 illustrates the internal details of portbuilder 124 from FIG. 1 in accordance with an embodiment of the present invention.

FIG. 3 is a flowchart illustrating the process of making the ports collection available to a user in accordance with an embodiment of the present invention.

FIG. 4 is a flowchart illustrating the process of a user installing and registering software packages in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Devices

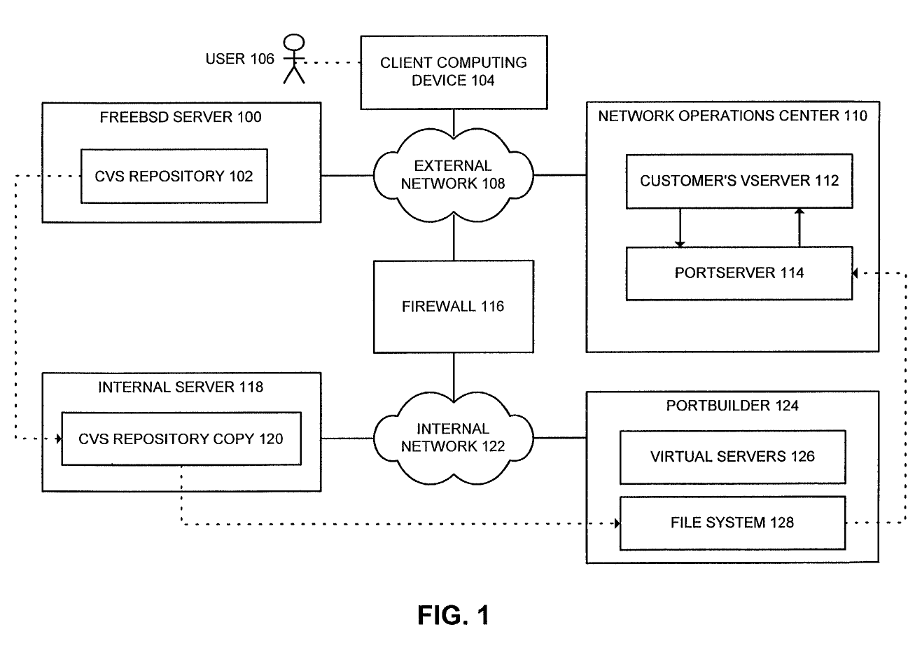

FIG. 1 illustrates a number of computing devices coupled together in accordance with an embodiment of the present invention. FreeBSD server 100, client computing device 104, firewall 116, internal server 118, portbuilder 124, portserver 114, and the computing device hosting customer's vserver 112 may include any type of computer system, including, but not limited to, a computer system based on a microprocessor, a mainframe computer, a digital signal processor, a personal organizer, a device controller, and a computational engine within an appliance.

External network 108 and internal network 122 can generally include any type of wire or wireless communication channel capable of coupling together computing nodes. This includes, but is not limited to, a local area network, a wide area network, or a combination of networks. In one embodiment of the present invention, external network 108 includes the Internet.

FreeBSD server 100 includes concurrent versioning system (CVS) repository 102. CVS repository 102 includes the source code and development files for the FreeBSD operating system and associated ports used by the CVS. CVS repository 102 may also be mirrored at other sites on the Internet. CVS repository 102 is maintained and updated as code developers submit new software to the FreeBSD group.

Internal server 118 copies, or mirrors, CVS repository 102 into CVS repository copy 120 at regular intervals, say twice per day. This is accomplished by sending appropriate messages across internal network 122, through firewall 116, across external network 108 to FreeBSD server 100. In response, FreeBSD server 100 returns a copy of the files in CVS repository 102 via the reverse path.

Firewall 116 allows messages from internal network 122 to pass to external network 108. However, firewall 116 allows only expected messages to pass from external network 108 to internal network 122. Thus, firewall 116 protects computing devices coupled to internal network 122 from attack by an entity on external network 108.

Portbuilder 124 builds FreeBSD operating system and the various ports. Included in portbuilder 124 are virtual servers 126 and file system 128. During operation, modifications may be made to any file within the system to effect local modifications to the FreeBSD operating system or any of the various ports. Next, portbuilder 124 copies CVS repository copy 120 to file system 128.

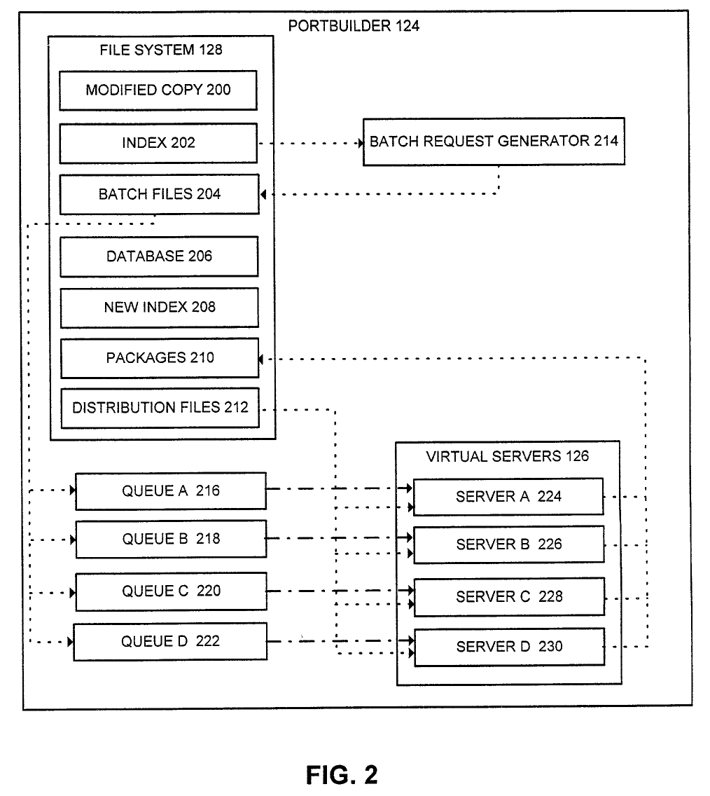

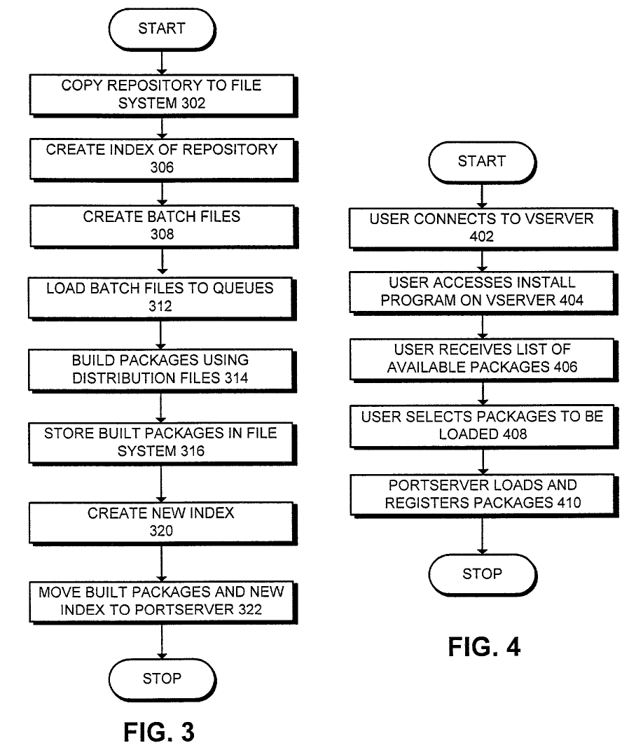

Virtual servers 126 include a plurality of virtual servers, which act as servers for building the FreeBSD operating system and the various ports as discussed below in conjunction with FIGS. 2 and 3. Each of virtual servers 126 is configured to act as an independent computing device even though they may all be contained within a single computing device such as portbuilder 124. In an alternate embodiment of this invention, virtual servers 126 may be distributed across several computing devices. The optimal number of virtual servers can be determined empirically so that each virtual server has a continuous stream of jobs and the number of virtual servers does not create significant overhead because of continual task switching. In one embodiment of this invention, there are four virtual servers within virtual servers 126.

Network operations center 110 includes customer's vserver 112. Customer's vserver 112 is one of a plurality of virtual servers within a computing device. Each customer or user has use of a virtual server, which gives the illusion of a dedicated computing device to the customer or user.

Portserver 114 is typically hosted on a different computing device locally coupled to customer's vserver 112. The executable operating system and port files are transferred to portserver 114 from file system 128 as described below in conjunction with FIG. 3. A customer or user can access the executable files from portserver 114 as described below in conjunction with FIG. 4.

Client computing device 104 allows the customer, user 106, to log on to customer's vserver 112 and to use the services provided to user 106.

The Portbuilder

FIG. 2 illustrates the internal details of portbuilder 124 in accordance with an embodiment of the present invention. Portbuilder 124 includes file system 128, virtual servers 126, batch request generator 214, and queues A-D 216, 218, 220, and 222.

File system 128 includes modified copy 200, index 202, batch files 204, database 206, new index 208, packages 210, and distribution files 212. The system copies CVS repository copy 120 into modified copy 200. Local modifications and enhancements are typically made and stored in CVS repository 102. However modifications and enhancements can also be made to the source code files within modified copy 200. After any desired modifications have been made, portbuilder 124 creates index 202, which contains a listing of all of the files that need to be compiled and linked to build packages 210. Included in index 202 is a listing of other packages upon which each package depends.

Batch request generator 214 uses index 202 to create batch files 204. Each batch file in batch files 204 contains the instructions for creating a package. These instructions include which files to compile, where the files are located, and how to generate the executable files for the package. Batch request generator 214 also designates which queue to use to process each batch file.

Portbuilder 124 uses database 206 to maintain data about the files and packages within the system, and what class of installation and support is assigned for each package. The installation and support classes are assigned to the packages within packages 210 to control access by user 106. The support and install classes are used to control which customers have access to the packages. Customers who pay for more services are given more access to the packages. As higher levels of access are purchased by user 106, more packages are made available to user 106.

New index 208 is created using data within database 206 and includes information about which packages have been built and are available. Appended to each entry in new index 208 are the fields indicating the support class and install class for each package and whether the package is being made available to customers.

The packages that have been built are stored in packages 210. In addition to storing the built packages, packages 210 is used to keep track of whether a package has already been built. If a package is already stored within packages 210, virtual servers 126 will not rebuild it.

Distribution files 212 store the source code files downloaded from the Internet. These files can be received in a format known as a .tar file. After receipt, portbuilder 124 unpacks the .tar file into separate source files and instruction files for building a package.

Portbuilder 124 distributes batch files 204 to queues A-D 216, 218, 220, and 222. As mentioned above, the optimal number of queues and the number of servers within virtual servers 126 can be determined empirically, and can be more than four or less than four. A queue, such as queue A 216, provides batch files from batch files 204 to an associated server, such as server A 224 within virtual servers 126.

Virtual servers 126 includes servers A-D 224, 226, 228, and 230. A virtual server, say server A 224, receives a batch file from its associated queue. This batch file contains instructions on how to build a package, and where the source files for the package are located. Dependencies are calculated by a script that reads the batch file and then generates the dependencies from index 202. Server A 224 also uses the same script to determine if the package has already been built. If so, server A 224 proceeds to the next batch file. If the package has not already been built, server A 224 retrieves the source files from distribution files 212 and creates the package using the instructions within the batch file. Upon completion, server A 224 stores the completed package in packages 210.

Building the Packages

FIG. 3 is a flowchart illustrating the process of making the ports collection available to a user in accordance with an embodiment of the present invention. A periodic process, not shown, copies CVS repository 102 to CVS repository copy 120 such that CVS repository copy 120 always contains an up-to-date copy of the FreeBSD operating system and ports collection. During operation, portbuilder 124 copies CVS repository copy 120, including any modifications, across internal network 122 to modified copy 200 within file system 128 (302).

After the CVS repository 120 has been copied, portbuilder 124 creates index 202 of modified copy 200 of the CVS repository (306). Batch request generator 214 uses index 202 to create batch files 204 (308).

Next, portbuilder 124 loads batch files 204 to queues A-D 216, 218, 220, and 222 (312).

Servers A-D 224, 226, 228, and 230 within virtual servers 126 use the batch files from their associated queue and files from distribution files 212 to build the packages (314). After each package has been built, portbuilder 124 stores the package within packages 210 (316).

After all of the packages have been built and are available in packages 210, portbuilder 124 creates new index 208 including the support class, install class and whether the package is provided (320).

Finally, portbuilder 124 moves packages 210 and new index 208 to portserver 114 (322).

Installing the Packages

FIG. 4 is a flowchart illustrating the process of a user installing and registering software packages in accordance with an embodiment of the present invention. The system starts when user 106 uses client computing device 104 to connect across external network 108 to customer's vserver 112 within network operations center 110 (402).

User 106 then accesses an install program on customer's vserver 112 (404). This install program accesses portserver 114 which returns a list of packages available to user 106 based on the user's level of access (406).

Next, user 106 selects the packages to be loaded from the available packages within portserver 114 (408). Finally, portserver 114 loads and registers the selected packages within customer's vserver 112 (410).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for building software packages, comprising:
receiving a collection of software source files from a remote repository across a network;
creating a batch file for each software package to be built, wherein the batch file specifies instructions for creating an executable file for each software package;
assigning the batch file to a queue of a plurality of queues, wherein each queue in the plurality of queues is associated with a virtual server in the plurality of virtual servers;
processing the batch file in a virtual server of the plurality of virtual servers, wherein the plurality of virtual servers can reside within one computing device, and wherein each virtual server of the plurality of virtual servers can provide essentially all services of a complete computing device; and
storing the executable file for each software package in a storage area, wherein a user can select a software package for use.

2. The method of claim 1, further comprising:
making modifications to a copy of a source file; and
copying the collection of source files to a local repository.

3. The method of claim 1, further comprising:
generating an index of software packages to be built; and
including packages within the index upon which the software package depends.

4. The method of claim 1, further comprising building packages upon which the software package depends prior building the software package.

5. The method of claim 1, wherein the batch file is assigned to the queue such that each queue of the plurality of queues has a substantially equal workload.

6. The method of claim 1, further comprising associating the queue with a specific virtual server, wherein the specific virtual server receives batch files from the queue associated with the specific virtual server only.

7. The method of claim 1, further comprising:
checking the directory structure to determine if the software package has already been built; and
if the software package has already been built, not building the software package a second time.

8. The method of claim 1, further comprising creating a new index of software packages in the directory structure for use by the user.

9. The method of claim 1, wherein the plurality of virtual servers can reside on multiple computing devices.

10. A computer-readable storage medium storing instructions that when executed by a computer cause the computer to perform a method for building software packages, comprising:
receiving a collection of software source files from a remote repository across a network;
creating a batch file for each software package to be built, wherein the batch file specifies instructions for creating an executable file for each software package;
assigning the batch file to a queue of a plurality of queues, wherein each queue in the plurality of queues is associated with a virtual server in the plurality of virtual servers;
processing the batch file in a virtual server of the plurality of virtual servers, wherein the plurality of virtual servers can reside within one computing device, and wherein each virtual server of the plurality of virtual servers can provide essentially all services of a complete computing device; and
storing the executable file for each software package in a storage area, wherein a user can select a software package for use.

11. The computer-readable storage medium of claim 10, the method further comprising:
making modifications to a copy of a source file; and
copying the collection of source files to a local repository

12. The computer-readable storage medium of claim 10, the method further comprising:
generating an index of software packages to be built; and
including packages within the index upon which the software package depends.

13. The computer-readable storage medium of claim 10, the method further comprising building packages upon which the software package depends prior to building the software package.

14. The computer-readable storage medium of claim 10, wherein the batch file is assigned to the queue such that each queue of the plurality of queues has a substantially equal workload.

15. The computer-readable storage medium of claim 10, the method further comprising associating the queue with a specific virtual server, wherein the specific virtual server receives batch files from the queue associated with the specific virtual server only.

16. The computer-readable storage medium of claim 10, the method further comprising:
checking the directory structure to determine if the software package has already been built; and
if the software package has already been built, not building the software package a second time.

17. The computer-readable storage medium of claim 10, the method further comprising creating a new index of software packages in the directory structure for use by the user.

18. The computer-readable storage medium of claim 10, wherein the plurality of virtual servers can reside on multiple computing devices.

19. An apparatus that facilitates building software packages, comprising:
a receiving mechanism that is configured to receive a collection of software source files from a remote repository across a network;
a creating mechanism that is configured to create a batch file for each software package to be built, wherein the batch file specifies instructions for creating an executable file for each software package;
an assigning mechanism that is configured to assign the batch file to a queue of a plurality of queues, wherein each queue in the plurality of queues is associated with a virtual server in the plurality of virtual servers;
a processing mechanism that is configured to process the batch file in a virtual server of the plurality of virtual servers, wherein the plurality of virtual servers can reside within one computing device, and wherein each virtual server of the plurality of virtual servers can provide essentially all services of a complete computing device; and
a storing mechanism that is configured to store the executable file for each software package in a storage area, wherein a user can select a software package for use.

20. The apparatus of claim 19, further comprising:
a modifying mechanism that is configured to make modifications to a copy of a source file; and
a copying mechanism that is configured to copy the collection of source files to a local repository.

21. The apparatus of claim 19, further comprising:
a generating mechanism that is configured to generate an index of software packages to be built; and
an including mechanism that is configured to include packages within the index upon which the software package depends.

22. The apparatus of claim 19, further comprising the creating mechanism that is additionally configured to create packages upon which the software package depends prior to creating the software package.

23. The apparatus of claim 19, wherein the batch file is assigned to the queue such that each queue of the plurality of queues has a substantially equal workload.

24. The apparatus of claim 19, further comprising an associating mechanism that is configured to associate the queue with a specific virtual server, wherein the specific virtual server receives batch files from the queue associated with the specific virtual server only.

25. The apparatus of claim 19, further comprising a checking mechanism that is configured to check the directory structure to determine if the software package has already been built so that the software package will not be built a second time.

26. The apparatus of claim 19, further comprising the creating mechanism that is additionally configured to create a new index of software packages in the directory structure for use by the user.

27. The apparatus of claim 19, wherein the plurality of virtual servers can reside on multiple computing devices.
